(19) United States
(12) Patent Application Publication
(10) Pub. No.: US 2008/0055885 A1
(43) Pub. Date: Mar. 6, 2008

(54) Display device

(76) Inventor: Jeffrey Marks, Newport Coast, CA (US)

Correspondence Address: Jeffrey S. Marks, 9 Chatelaine, Newport Coat, CA, 92657, US

(21) Appl. No.: 11/822,163

(22) Filed: Jul. 3, 2007

Related U.S. Application Data
(60) Provisional application No. 60/842,027, filed on Sep. 5, 2006.
(60) Provisional application No. 60/845,750, filed on Sep. 20, 2006.

(51) Int. Cl. F21V 33/00

(52) U.S. Cl. 362/101

(57) ABSTRACT

A multi-functional decorative display device as shown and described.

### PRIORITY CLAIM

This application claims the benefit of U.S. Provisional Patent Application Nos. 60/842,027, filed Sep. 5, 2006, and 60/845,750, filed Sep. 20, 2006, the disclosures of which are hereby incorporated by reference.

### BACKGROUND OF THE INVENTION

1. Technical Field

The present invention relates to decorative displays incorporating fluid motion, light and other visual properties.

2. Description of Related Art

A. Decorative Lamps

Lava lamps are decorative lamps wherein a globule or globules of one fluid is suspended in another fluid, and the application of heat to a transparent or translucent container causes convection currents which give rise to the display of the globule or globules simulating the flow of volcanic lava, such as the lava lamps described in U.S. Pat. No. 71,662 (T. A. De Vilbiss), U.S. Pat. No. D437,965S (J. Diviak, Sr.) and U.S. Pat. No. D438,329S (Diviak, Sr.).

A decorative lava lamp display device described in U.S. Pat. No. 3,387,396 of Smith, reveals an electric lamp in the form of an electric bulb in a base illuminating and heating a transparent enclosure containing two different immiscible fluids of slightly different densities. In Smith '396, globules of contrasting colored dense fluids gently flow upward and then downward under the influence of internal convection currents and gravity.

See also, U.S. Pat. No. 6,604,835 B2 of Zale, which discloses a lava lamp which incorporates vibrant, lighted granules of gems, such as diamonds, flowing through the display; See also, U.S. Pat. No. 4,170,035, of Walker, which discloses a lava lamp that includes insoluble light reflecting particles suspended within fluid, having substantially the same specific gravity, from which light reflects outwardly through the container. See also, decorative display lamp device described in U.S. Pat. No. 3,570,156 of Walker et al., which includes in one of the fluid components, an additional substance which has the effect of raising the coefficient of cubic thermal expansion of the water alone, which overcomes certain disadvantages disclosed in prior patents.

B. Display Devices

A number of prior patents disclose display devices that include transparent containers with fluid therein. For example, U.S. Pat. No. 5,106,660 issued to Vorel, discloses a decorative wall panel comprising two parallel, vertically disposed spaced panes of glass that are sealed along the bottom and side edges. The panels form a space that is filled with fluid. At the bottom of the space is a porous tube through which air is dispersed to generate a curtain of bubbles that rises through the fluid. The curtain of bubbles is illuminated by lights disposed at the edges of the panel.

U.S. Pat. No. 6,187,394 issued to Johnson et al., discloses a bubbling fluid display device that includes a variable-pressure air source which injects air into a fluid within a panel at variable flow rates into a number of individual chambers to create a unique bubbling pattern for each chamber which includes large bubbles which move upwards within the fluid in the display, and smaller bubbles which move downwards within the fluid in the display.

U.S. Pat. No. 5,363,577 issued to Fuller et. al., discloses a fluid display device comprising a plurality of adjacent, parallel tubes filled with a fluid and connected to an air source that injects bubbles into the tubes. The display further comprises a computer that controls the introduction of bubbles to each tube such that the combination of bubbles form a legible design, such as a picture or a word.

U.S. Pat. No. 5,683,174 issued to Lena, Jr., discloses an artistic display that directs light through a panel containing at least two fluids with different colors of specific gravities to project a constantly changing wave pattern onto a display surface. The wave pattern results from the slow oscillation of the panel containing the fluids.

U.S. Pat. No. 5,636,669 issued to Price, discloses a system whereby lightweight powdered or colored substances are introduced into hollow transparent panels to selectively change the color of the panels.

There are various shortcomings of previously disclosed fluid based displays and lamps. While prior art provides for pumping a fluid or bubbles into a transparent panel to change the appearance thereof, no existing patents disclose a method for combining the convection features utilized in lava lamps into a large decorative display. In the prior art, the size and height of the lava lamp device is restricted because the heating device is located at the base of the lamp. The height to which the first fluid can rise before cooling enough to regain its weight and sink back to the bottom, it limited. As a result, typical lava lamps have heights of between 10 and 27 inches, and diameters of between 3.25 and 8.25 inches, with the largest lava lamp we found being 56 inches tall with a diameter of 26 inches. In addition, the prior art includes lava lamps containing only two types of fluids comprising 2 colors. Further, the prior art is limited because it contemplates only one chamber through which the component fluids move. Further, the prior art does not incorporate bubbles within and around the globules to achieve additional effects, or an electronic means for providing the fluids to respond and move as a result of sound or vibrations. Finally, the prior art is limited because the falling of the first component fluid as it cools is uncontrolled and random. There is a need for an improved fluid display device and the devices and technology described herein touch on all of these issues to provide for a unique and attractive display that can be located among other places, in a home, a business or a nightclub.

### BRIEF SUMMARY OF THE INVENTION

The present invention relates to the creation of a fluid based visual display. It, among other things, incorporates, but enhances, lava lamp technology, so that effects similar to those seen in lava lamps, can be achieved on a larger scale than currently possible under the prior art. The present invention also incorporates additional steps and technologies that operate to create new effects not currently possible under current designs. In keeping with these objects, one embodiment of this invention provides a display panel or tank that can be free standing, or incorporated into a partition section, a ceiling, floor or wall hanging unit. Another involves a tank that can be of various shapes and sizes and can be free standing, imbedded in a wall or in a furniture unit.

According to one embodiment of the invention, an enclosed device is created that includes two panels at least one of which is a transparent pane. The distance between the panels may vary from a few centimeters to several feet. The space in between the panels contains fluids of different densities, weights or viscosities and differing colors. During operation, one or more fluid components are in the form of one or more globules which are suspended in a second fluid component that is immiscible therewith. As with lava lamps, the said display properties consist of the first fluid component ascending under the influence of heat and circulating in the second fluid component to produce shapes and/or patterns. The initially solid first component is heavier at room temperature and is therefore located at the base of the device and receives heat from one or more heat sources in the base. The first component fluid becomes fluent and, upon continued heating, its specific gravity eventually decreases relative to that of the second component, whereupon the first component fluid rises within the second component. An additional heating device is incorporated into the display at approximately the height at which the first component will have moved a sufficient distance from the heat source to cool and begin dropping to the bottom. One or more additional heating devices may be incorporated at various incremental heights or in one continuous strip. These additional heating devices reheat or continue heating the first component such that the first component continues rising up through the tank. The tank incorporates other devices described below to enhance and change the visual display.

It is therefore an object of the present invention to:

1. Provide for the elements of a decorative lava lamp (in which one or more fluid components are in the form of one or more globules which are suspended in a second fluid component that is immiscible therewith), to be incorporated into a larger visual display.

2. To incorporate multiple heating and/or cooling devices that can increase or shorten the distance the second fluid can rise, and which can otherwise control both the rising and falling of the second fluid.

3. Incorporate multiple colors and visual effects such as bubbles into the display.

4. Incorporate an effect whereby sound and/or vibrational currents impact the movement of the liquids or otherwise impact the display.

5. Incorporate one or a plurality of chambers, apertures and/or barriers through which the fluids can circulate, which result in unique configurations, separations and shapes.

Those of ordinary skill in the art can appreciate that different fluid or chemical solutions may be used for different desired effects. Those of ordinary skill in the art can also appreciate that other non-light producing heat sources can be used alone or in connection with other light sources to create the desired effects.

### DETAILED DESCRIPTION OF PREFERRED EMBODIMENTS

### Interpretation Considerations

When reading this section I have described several preferred embodiments of the invention, however, one should keep in mind several points. First, the following preferred embodiments are what the inventor believes to be the best mode for practicing the invention at the time this patent was filed. Thus, since one of ordinary skill in the art may recognize from the following preferred embodiments, that substantially equivalent structures or substantially equivalent acts may be used to achieve the same results in exactly the same way, or to achieve the same results in a not dissimilar way, the following preferred embodiments should not be interpreted as limiting the invention to those embodiments.

Likewise, individual aspects of the invention are provided as examples, and, accordingly, one of ordinary skill in the art may recognize from a following preferred structure (or a following preferred act) that a substantially equivalent structure or substantially equivalent act may be used to either achieve the same results in substantially the same way, or to achieve the same results in a not dissimilar way. Furthermore, it is recognized that as technology develops, a number of additional alternatives to achieve an aspect of the invention may arise. Such advances are hereby incorporated herein, and should be recognized as being functionally equivalent or structurally equivalent to the aspect shown or described herein.

A function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

### Discussion of Figures

FIG. 1 is one depiction of a multiple compartment tank which includes a tank base 1, three lamps 2, 3 & 4, in the lamp base, incremental heating or cooling devices 5-10 affixed to the back of the tank, and one long heating or cooling device in the form of a strip 11 affixed to the back of the tank. FIG. 1 is divided into three separate compartments 12, 13 & 14. FIG. 1 also includes a plurality of tubing 15 & 16, affixed to a pump 17 located in the housing at the top of the tank, through which one or more component fluids that rise to the top of the tank are pumped down through either side of the tank casing and delivered back to the base of the tank 1. One of the tubes is equipped with a heating device 18 which heats the fluid in order to maintain its fluidity or viscosity while being transported through the tube.

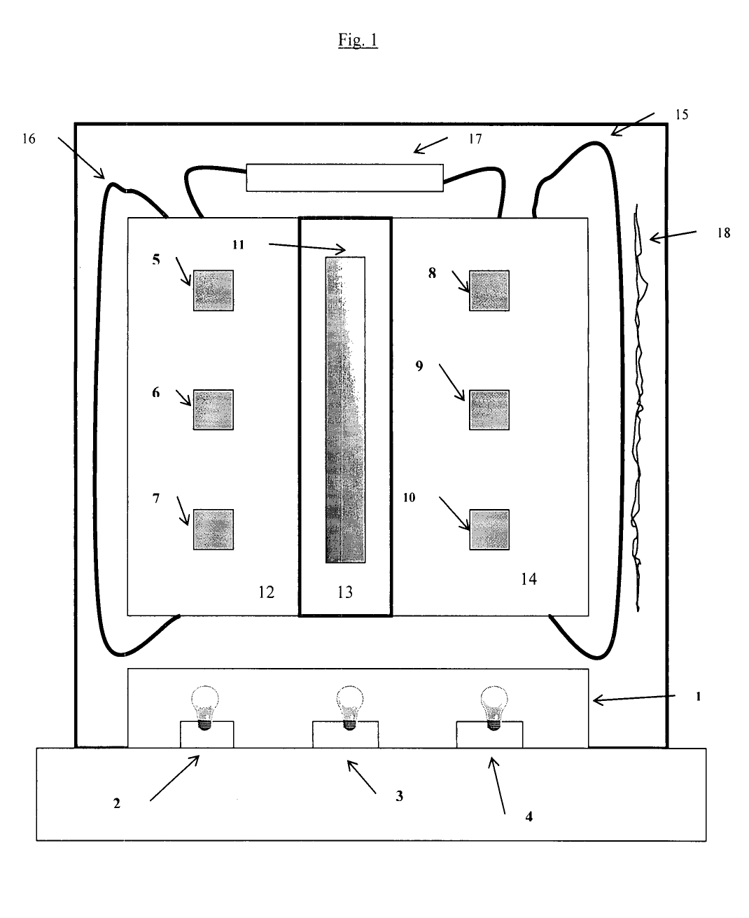

FIG. 2 is a depiction of a tank with a single compartment which includes a tank base 19, two lamps 20 & 21, in the lamp base, an intertwining path of barriers 22, 23, 24, 25 & 26, which guide the flow of the liquid in a FIG. 8 shape. FIG. 2 also includes a flap/valve mechanism 27, which permits the flow through of rising fluid, however, prevents the flow through of falling liquid. FIG. 2 also includes a heating/cooling strip 32 imbedded in the back of the tank which runs the length of the path of barriers so as to maintain or effect the convection of the fluids traveling through such barriers. FIG. 2 also includes a tube 28, through which falling fluid may travel. FIG. 2 further depicts an apparatus 29 which injects dye, bleach or other chemical components into the tank which have the effect of altering the color, appearance or viscosity of one or more fluids contained within the tank. FIG. 2 also depicts a water pump device 31 to which one end of a tube 31A is connected, the other end of the tube being connected to a location in the tank 31B, and through which water or other fluids are pumped at varying forces into the tank at specific locations to effect the path or change the visual effects of the fluids within the tank. FIG. 2 also depicts a sound control device 38 which has the effect of changing the visual display effects based on rhythm, sound and/or music. FIG. 2 further depicts a computer 30 which is connected 33, 34, 35, 36 & 37 to the various electronic components of the tank, which control the activities of such devices and thereby effect the workings of the tank.

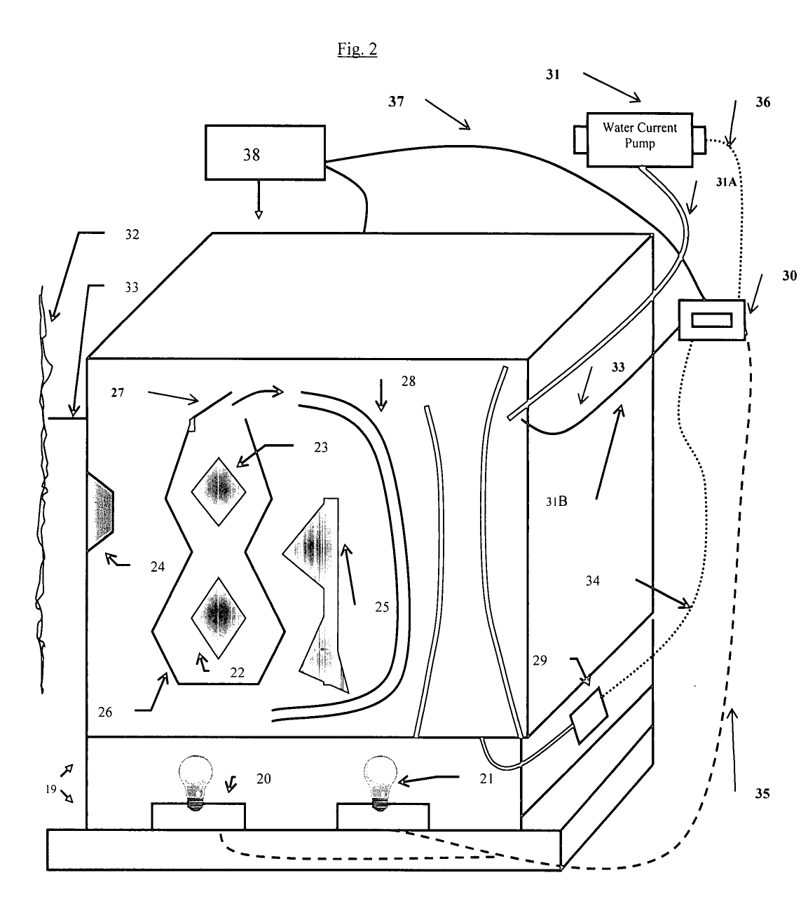

FIG. 3 is a depiction of one potential shape of a tank with a tank base 38, a lamp 39, and an elongated heating/cooling strip 40 imbedded in the back of the tank which runs the approximate height of the tank. FIG. 3 also includes a translucent barrier 41 & 42 which directs and controls the flow of the liquid. FIG. 3 also includes a flap/valve mechanism 43, which permits the flow through of rising fluid, however, prevents the flow through of falling liquid.

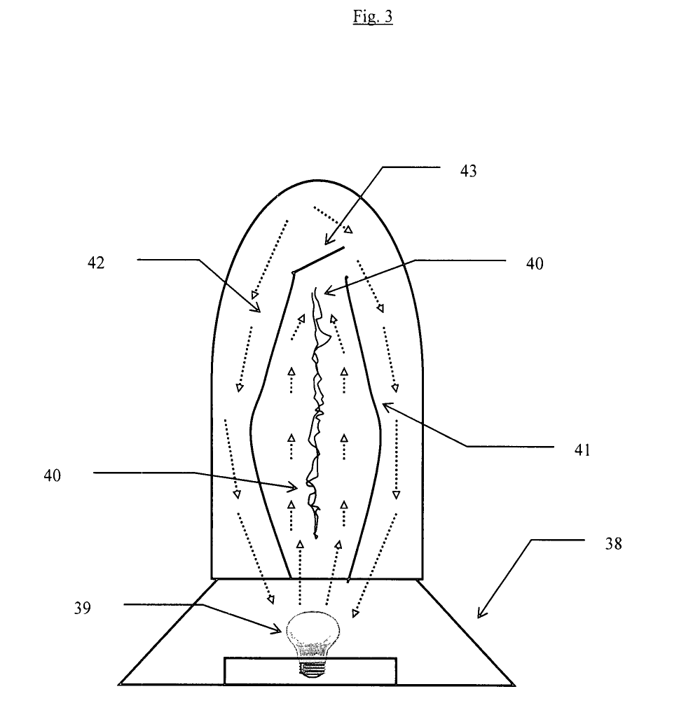

FIG. 4 is a depiction of a tank that has a tank base 44, which includes a non-illuminate electric heating source 45 in the tank base. FIG. 4 also includes barriers of various shapes and sizes 46-51 which control and alter the flow of liquid rising and falling within the tank. FIG. 4 also includes a barrier that is a pinwheel 52 that moves in a circular motion as liquid rises or falls thereon. Incorporated within certain of the barriers of FIG. 4, are heating/cooling devices which affect the rising and falling of the fluid. FIG. 4 also depicts a plurality of lighting devices 52A which when cast through the tank create additional visual effects.

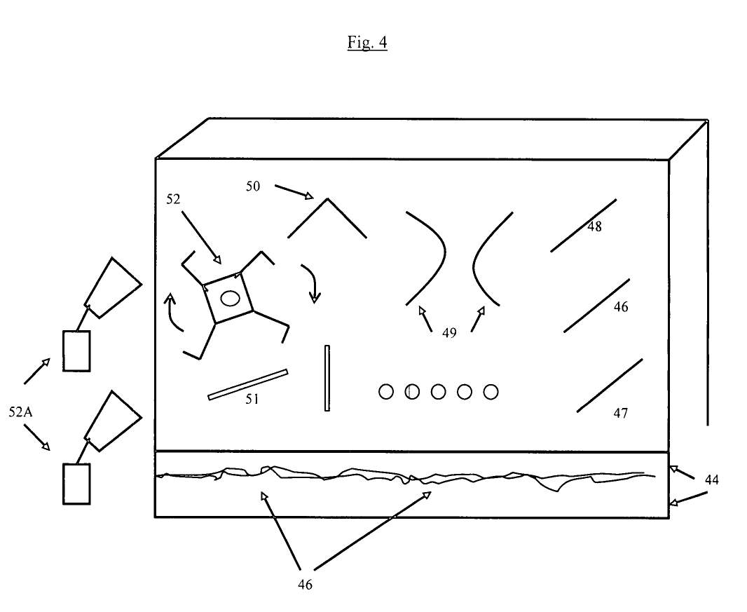

FIG. 5 is a depiction of a three-compartment tank with the first compartment 53 located in the front, the second compartment 55, located in the back, and the third compartment 54, located between the first compartment 53 and the second compartment 55. The compartments are separated by translucent barriers 55A & 55B. The first compartment 53 serves as an actual fish tank, the second compartment 55 displays bubbles rising through the water via a mechanism 56 built under the tank housing, and the third compartment 54 includes the heating and cooling rising and falling fluid effects as described in the prior figures. A motion generating means 65 imparts an oscillating pivotal motion to the second compartment 55. The motion generating means 65 preferably comprises a motor 59 that turns a cam 60 and a pivot arm 58 to pivot the second compartment of the tank 54. The pivot arm 58 is secured to one of the ends 56A of the second compartment 55 of the tank. Preferably, the motor 59 pivots the cam 60 and pivot arm 58, and thus the second compartment 55, in a range of motion preferably between approximately −6.5. degree. and +6.5. degree. inclination from level at a preferable speed of approximately 2.5 to 6 rpm. However, the exact range of motion desirable by the motion generating means 65 depends on the size and dimensions of the container, the viscosity of the fluids and the constraints of the particular environment in which the liquid display system is installed. Preferably, the system also includes a means 57 by which to control the speed at which the motion generating means 65 pivots the second compartment 55. The light directing means 62 preferably comprises a lamp assembly having a reflector. The lamp is preferably of the incandescent, halogen or xenon type. The light means 62 is preferably centered beneath the bottom of the second compartment 55, so that light is projected through the phenomenon created by the bubbles generated in the second compartment 55 and toward an outer surface 66. A means 61 for controlling the intensity of the output of the lamp 62 is preferably provided so as to enable a user to soften or enhance the refracted light pattern on the displaced surface 66. A colored, light-transmissive element 63 may additionally be placed between the light directing means 62 and the second compartment 55 so as to impart color to the light beam. The element 63 may consist of a colored filter, gel or other such means. Alternately, one or more of the liquids included in the second compartment 55 may be naturally or artificially colored.

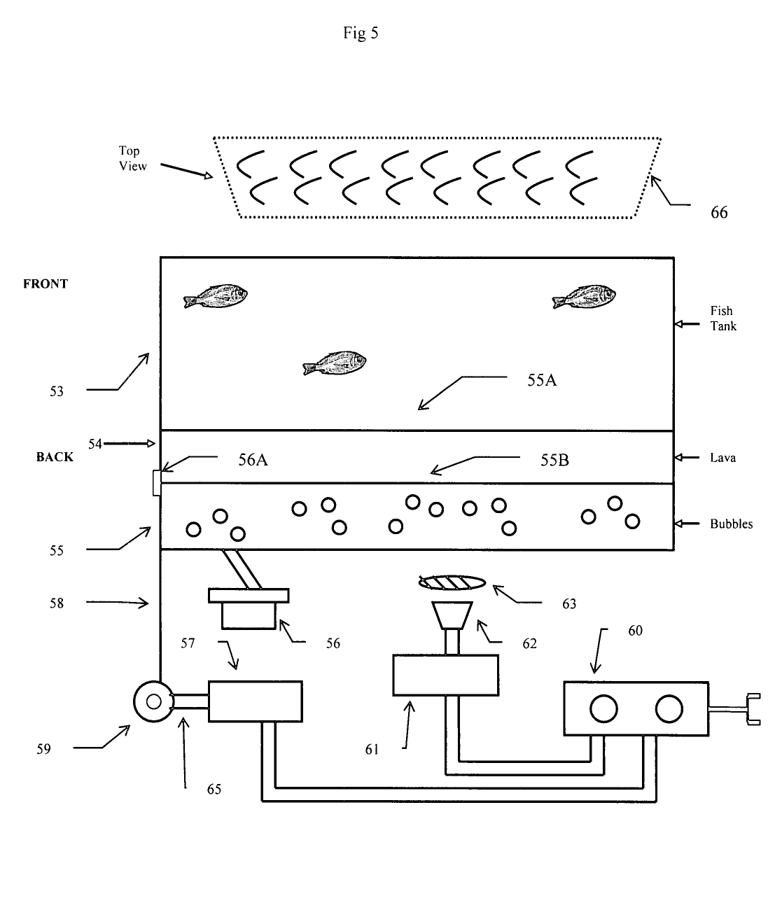

FIG. 6. is a depiction of a tank that has a tank base 67, which includes a lamp 68 in the tank base. FIG. 6 also incorporates various heating/cooling devices 69-74 which effect the rising and falling of the fluid. FIG. 6 also includes a plurality of tubing 76-79, affixed to a pump 75, through which one or more component fluids are pumped down through the tubes on either side or the back of the tank casing and delivered back to the base of the tank.

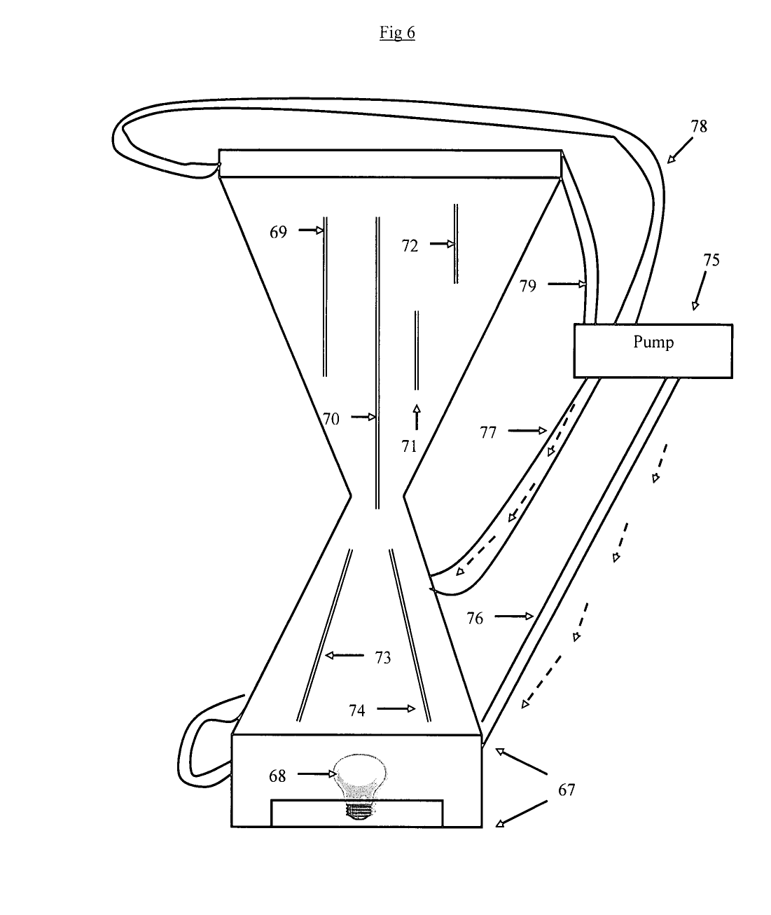

FIG. 7 depicts a close up of the top portion of FIG. 6, depicting barriers that may be included therein and which would have the effect of altering or directing the flow of the component fluids either rising or falling within the tank.

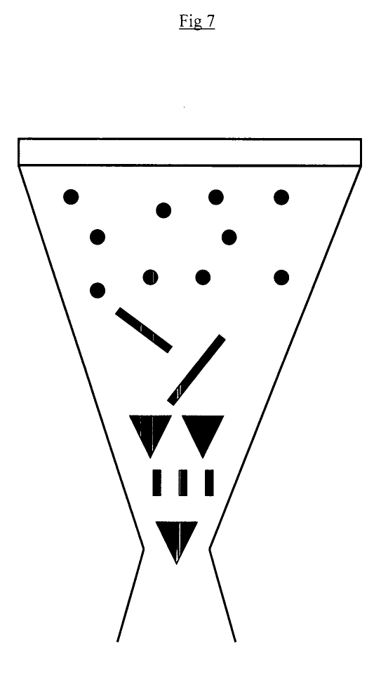

I claim:

1. An enclosed tank which may be built into a wall or ceiling as a panel or otherwise, or incorporated into a unit of furniture, or which may be free standing, comprising: one or more compartments having a visually perceivable inner surface; and, a heat source at the bottom of the tank housing heating said housing, which contains two fluids, the first of which is denser, wherein said fluids move under the influence of internal convection currents within said tank, and by the force of gravity. One of ordinary skill in the art can appreciate that such heating sources can include light, chemical heating elements, electricity, heated fluid being pumped into the tank or any number of other sources. One of ordinary skill in the art can also appreciate that such heating source may be located within the tank, within the tank housing, or outside of the tank. One of ordinary skill in the art can further appreciate that the heat source may or may not have illuminating properties, and that if such heating source emits visible light, that such light could be of any one color or multiple colors, or could be one of any type of frequency on the radio wave spectrum.

2. The tank as in claim 1 where the tank contains one fluid, or three or more fluids, with differing densities, which move (at the same or different speeds) under the influence of internal convection currents within said tank, and by the force of gravity.

3. The tank as in each of claims 1 & 2 above, that contains at least one immiscible fluid (which may be comprised of silicone or some other viscous substance) within said tank housing of sufficient viscosity, to act as a lubricant as at least one of the initial dense fluid components moves through the inner surface of the tank housing.

4. The tank as in each of claims 1-3 above, wherein there is a plurality of dense fluids, wherein (a) one of said fluids forms at least one globule flowing within said other dense fluid, or (b) at least one dense fluid forms at least one globule flowing within said other fluids, and at least one other dense fluid forms at least one globule flowing within said first globule, or (c) at least one dense fluid forms at least one globule flowing within said other fluids, and at least one other dense fluid forms at least one globule flowing within said first globule, and at least one further dense fluid forms at least one globule flowing within said second globule.

5. The tank as in each of claims 1-4 above, wherein there are multiple heating sources contained in the tank housing at various heights (or one or more large or long heating sources running along, within or behind a wall of the tank, or otherwise contained within the tank), which continue the convection current and enables the first component fluid to continue rising.

6. The tank as in each of claims 1-5 above, wherein there are one or more cooling sources contained in the tank housing (or one or more large or long cooling sources running along, within or behind a wall of the tank, or otherwise contained within the tank), which can influence the weight and gravity of the first component so as to result in a sinking of the first component at a desired point. One of ordinary skill in the art can appreciate that such cooling sources can be cold fluid pumped into the tank, refrigeration tubes, chemical coolants, or any number of other sources.

7. The tank as in each of claims 1-6 above, wherein the amount of heat or cold generated by each heating or cooling source can be increased or decreased either manually or by computer.

8. The tank as in each of claims 1-7 above, wherein all or a portion of the tank walls are translucent. One of ordinary skill in the art can appreciate that such translucent walls can be achieved using glass, fiberglass resin, polycarbonate or any other material that would have the a translucent effect.

9. The tank in each of claims 1-8 above, that includes one or more pumps contained within the casing at the top of the tank, on either or both sides of the tank, behind the tank and/or at the bottom of the tank, which contain tubing (or some other separate passageway) which is sufficiently heated (or cooled) to maintain the viscosity of one or more of the component fluids, so as to enable it to suck up such component fluid(s) and transport it/them through said tubing (or other separate passageway), to another location within the tank.

10. The tank as in each of claims 1-9 further comprising an inner reflector reflecting emitted light from said tank toward one or more light transferable walls of said tank housing.

11. The tank as in each of claims 1-10 that includes multiple compartments, tubes, barriers or obstructions which split, combine or otherwise alter the course of a component fluid as it rises and/or falls.

12. The tank as in claim 11 wherein said compartments, tubes, barriers or obstructions include a valve, a flap or other device that opens as fluid is rising or falling in a specific direction (ie., up), and closes when fluid is rising or falling in the opposite direction (i.e., down), thereby diverting the flow of the rising or falling fluid.

13. The tank as in each of claims 11 and 12 wherein, all or some portion of said compartments, tubes, barriers or obstructions includes a heating and/or cooling device that has the effect of changing the density or viscosity of, or otherwise changing the fluid contacting or in the vicinity of such obstruction, such that such fluid is broken into two or more streams or globules, combines or changes course.

14. The tank as in each of claims 5-13 wherein the temperature of such heating and cooling devices can be varied manually or by computer.

15. The tank as in each of claims 1-14 which includes a means of dynamically changing the color of one or more of the fluids through the use of lighting effects (such as reflecting different colors or frequencies of light or radio waves on the fluid from a source inside or outside of the tank), and/or dyes, bleaches, other coloring agents or other means.

16. The tank as in each of claims 1-15 which includes a means of dynamically changing the viscosity, movement and/or motion of one or more of the fluids through the injection of chemicals, the application of cold, hot or neutrally temperatured water, or some other method.

17. The tank as is claims 1-16 which incorporates mirrors at the top, bottom, sides and/or back of said tank which have the effect of varying the visual effects of the display through the interaction of light.

18. The tank as in each of claims 1-17 which includes two or more separate cavities or spaces which are separated by translucent plates or panes (which could be glass, fiberglass or some other transparent material), each of which cavities or spaces incorporates none, some or all of the concepts described in claims 1-18 above, and which may or may not be linked together by tubes or other means such that the fluids can be circulated between or among such separate cavities or spaces.

19. The tank as in each of claims 1-18, which incorporates the elements of vibrational frequencies or otherwise incorporates an electronic device which causes the visual effects to vary as a result of music, rhythms or sounds.

20. The tank as in each of claims 1-19, which incorporates one or more variable-pressure sources which inject air, water and/or some chemical or other substance into that tank at variable flow rates to manipulate or alter the appearance or flow of one or more of the liquids or to create some visual effect (such as creating a bubbling pattern).
It can be appreciated that some or all of the features and technologies described above can be incorporated into smaller devices to create lava lamps or other small displays that incorporate the new added effects described herein, and this application is intended to include the same. It cah also be appreciated that some or all of the features and technologies described above can be incorporated with other patents and technologies to create similar or unique effects.
Further, the claims above should not be constructed to be limited by the other in which they are listed or by the specific references back to certain claims, however, should be constructed so as to combinable in any order with any of the other claims set forth above.
